(19) United States
(12) Patent Application Publication
(10) Pub. No.: US 2016/0098534 A1
(43) Pub. Date: Apr. 7, 2016

(54) PRESCRIPTION MONITORING PROGRAM ACCESSING SYSTEM

(71) Applicant: Todd A. Helfman, Sylvania, OH (US)

(72) Inventor: Todd A. Helfman, Sylvania, OH (US)

(21) Appl. No.: 14/875,038

(22) Filed: Oct. 5, 2015

Related U.S. Application Data
(60) Provisional application No. 62/060,102, filed on Oct. 6, 2014.

(51) Int. Cl. G06F 19/00

(52) U.S. Cl. CPC G06F 19/3456; G06F 19/322

(57) ABSTRACT

Method, system, web-based, or stand-alone software application which enables a PMP user, through integration with an existing electronic health record (EHR) or other database, to easily, and quickly transfer patient demographic information for submission to a regional, state, provincial, multi-state, private, or national system PMP. This PMP accessing method and system may be web-based or stand-alone software application provide a user-interface that easily enables the direct transfer of individual demographic information required by the prescription monitoring program (PMP) to the PMP database to obtain a prescription report quickly and efficiently circumventing manual data entry.

### FIELD OF USE

The present invention relates to an efficient and expeditious way for physicians, health care professionals, law enforcement, and probation agencies, health and human services, or any other entity or individual or entity with access, to enter patient demographic information into state, private, regional, or national prescription monitoring programs (PMP).

### BACKGROUND OF THE INVENTION

It is estimated that about 3.9 billion (3.9 thousand million) prescriptions were written in the United States in 2013. This number has grown from 1.5 billion in 1989 and is expected to continue to grow. Prescriptions are subject to forgery and have become a simple way to obtain narcotics, which are cheaper and safer as prescription drugs than as street drugs. Forgery can take many forms: stolen prescription pads, alterations of legitimate prescriptions including dispensed amount and number of refills, falsified call back numbers, addresses and name changes, and phoned or faxed prescriptions easily faked among other creative methods.
U.S. Patent Document No. 20140012600 (Domesek, et al.) discloses a computer-implemented system for preventing prescription abuse. The system includes a secure login for both physicians and pharmacists. A prescribing physician submits a prescription request to the system after selecting an intended patient, after which the system generates a unique prescription code derived from the patient history and prescription medication request. The physician is able to include this unique code on the prescription, thereby enabling a pharmacist to ensure the prescription has not been tampered with.
U.S. Patent Document No. 20120278096 (Holness) discloses a system, methods and devices for prescription drug authentication and more specifically a portable hand-held device and system for prescription drug authentication to be conducted ad hoc. Although preferred embodiments of the invention are explained in detail, it is to be understood that other embodiments are contemplated.
U.S. Patent Document No. 20140149131 (Bear; et al.) discloses methods and systems of patient compliance monitoring. Patient compliance monitoring includes receiving, from a user, a specification of a patient and retrieving prescription data associated with the specification. Compliance monitoring further includes receiving one or more codes associated with a dispensed prescription and determining whether the patient is compliant with the prescription data as a function of the prescription data and the one or more codes. Compliance monitoring also includes communicating an indication of whether the patient is compliant to the user.
U.S. Patent Document No. 20080059226 (Melker; et al.) discloses systems and methods for monitoring prescription medications. In particular, systems and methods are provided for monitoring patient compliance with a given prescribed regimen as well as monitoring the origins of a prescription drug. The subject invention provides a central computer and a portable device, wherein the portable device includes at least one sensor for detecting a target marker. The target marker of the invention represents, either the presence of a specific prescribed medication, or identifies the proper origins of a medication.

Prescription Monitoring Programs (PMPs) or Prescription Drug Monitoring Programs (PDMPs) are programs and databases that accumulate and store federally controlled substance information as it pertains to the individuals/patients obtaining them. These systems have been instrumental in limiting drug abuse and preventing controlled substances from being used for any purpose other than their original implied intent.

PMPs assist PMP users to obtain insights into the use of controlled substances by the individual in question in an effort to prevent abuse or diversion of these prescribed drugs.

PMPs have become a major factor and a vital force in identifying individuals with substance abuse problems while preventing them from visiting multiple subscribers to obtain similar controlled substances. Among other benefits, PMPs help to change the prescription habits of physicians and dispensing habits of pharmacists, while giving PMP users a clearer picture of what medications and dosages a patient is taking.

There currently exists a variety of PMPs each of which has a different patient demographic requirement to process a submission. PMP users have access to patient demographic information typically through electronic databases such as electronic health records (EHRs) or the like. There exists a tremendous variety of electronic databases utilizing this information making it difficult to standardize the transfer of demographic information from the electronic database to the PMP without inputting the information manually to generate a useful report, which is time consuming.

Whether in a crowded emergency facility in a hospital or in an office-based pain-management practice, time is critical. The PMP systems are cumbersome and can delay medical care to patients in dire need. Legal mandates requiring the use of PMPs before prescribing any controlled substance that may be beneficial to ailing patients, can tie up health care providers for hours each day, delaying the delivery of patient care.

What is needed is a direct communication link between the PMP user database and the PMP database to improve efficiency and minimize unnecessary delays to improve patient care.

What is needed is a system that enables health-care professionals and their delegates to enter and submit patient demographic data quickly and accurately from the specific users' database to the wide variety of PMPs that circumvents manual data entry, saves time, and is cost effective.

What is needed is a system and method to enable a PMP user to avoid manual entry of patient data and to enter such patient demographic information into a PMP website or database expeditiously, and efficiently.

### SUMMARY OF THE INVENTION

The PMP accessing system of the present invention addresses these critical needs.

As used herein, the term “PMP” refers to either a prescription monitoring program or a prescription drug monitoring program operated by a private organization or unit of government, such as region, state, multi-state, province, or country.

As used herein, the term “PMP users” refers to physicians, pharmacists, health-care professionals, delegates, law enforcement personnel and agencies, and any individual or entity having access to a PMP.

As used herein, the term “patient” refers to the person, client, parolee, and the like seeking treatment or seeking a controlled substance.

The PMP accessing system of the present invention, either as a stand-alone utility, within a form of electronic database such as an electronic health record, or integrated directly within a PMP in a region, state, provincial, multi-state, private or national system, enables the user to quickly upload a patient's demographic information from the PMP database without concern of specific data required by the PMP, as the system is intended to manipulate the current information by formatting, extracting what is necessary, and submitting it in a matter of seconds, circumventing manual entry while saving time and resources. All activities can be performed within the system of the present invention safely and securely.

Aside from report generation, the PMP accessing system of the present invention may also be used to submit current prescription information to a PMP. A pharmacist, or a pharmacist delegate, can directly transfer demographic information included within their database, using the PMP accessing system of the present invention, to gain quick access to the point within the PMP database specific to the patient whose prescription information they are attempting to record for future retrieval and scrutiny by other PMP users.

The PMP accessing system of the present invention dramatically reduces the time PMP users need for logging into and obtaining a prescription report.

PMP users can then access the PMP database for a regional, state, multi-state, provincial, private, or national system and can simply copy and paste the patient demographics directly from the current electronic database. The PMP accessing system of the present invention formats and submits the information to the regional, state, multi-state, provincial, private, or national system PMP in seconds.

The PMP accessing system of the present invention converts the demographic information included within the various electronic databases used by PMP users in order to bridge the gap between the user's database and the regional, state, multi-state, provincial, private, or national system PMP.

In another preferred embodiment, the PMP accessing system of the present invention is accessible via a web browser or web browser toolbar, enabling the PMP user to cut and paste, scan, or by other means to upload the necessary patient demographic information required by each PMP.

The PMP accessing system enables PMP users to quickly access, upload, format, and submit demographic information to a regional, state, provincial, multi-state, private or national system PMP circumventing manual data entry.

For a complete understanding of the PMP accessing system of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 shows a schematic block diagram demonstrating some of the embodiments and use flow of the preferred embodiment of the PMP accessing system of the present invention in a single diagram.

FIG. 2A depicts a first preferred embodiment of a PMP user device for use with the preferred embodiment of the present invention for the login of the PMP accessing system of the present invention.

FIG. 2B depicts a second preferred embodiment of a PMP user device for use with the preferred embodiment of the present invention for the login of the PMP accessing system of the present invention including bimodal biometric authentication.

FIG. 3 depicts the preferred embodiment of the present invention for the user-interface of the PMP accessing system of the present invention.

FIG. 4 shows a schematic block diagram demonstrating the formatting method of the PMP accessing system of the present invention.

FIG. 5 depicts the preferred embodiment of the present invention for the settings of the PMP accessing system of the present invention.

FIG. 6 depicts an alternate preferred embodiment for the prescription monitoring program accessing system display and user-interface of the prescription monitoring program report of the present invention.

FIG. 7 depicts an example of an Electronic Health Record (EHR) with the patient demographic information required to obtain a prescription monitoring program (PMP) report.

### DETAILED DESCRIPTION OF THE PREFERRED EMBODIMENTS

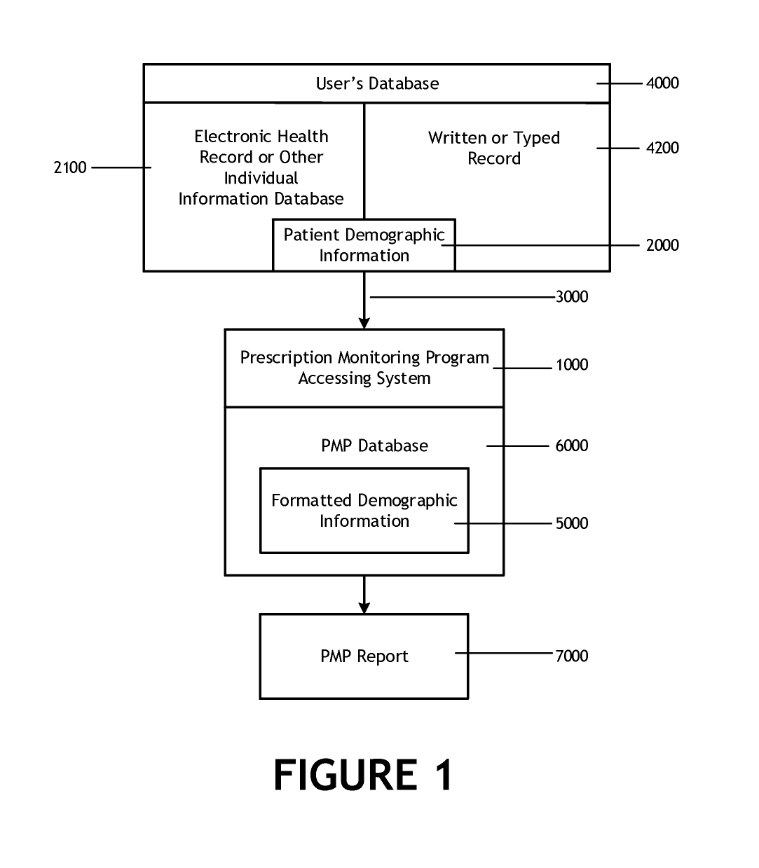

Referring now to the drawings, FIG. 1 discloses a database (4000) which can be, but is not limited to, an electronic health record (2100), a written or typed patient document (4200) or other database (4000) utilized by a PMP user including the particular patient demographic information (2000) of interest, required by the PMP to obtain a prescription report, is accessed in the usual fashion.

The demographic information (2000) included within the user's database (4000) is isolated through, but not limited to, copy and paste functionality, scan, upload, optical character recognition, application programming interface (API) connectivity, or screen capture (3000).

Following the transfer (3000) of demographic information (2000) to the PMP accessing system (1000), the data is formatted from the database (4000) having the demographic information (2000) within the PMP accessing system (1000) to comply with the specific demographic information details required by the PMP to generate a prescription report. Once formatted (5000), the demographics are appropriately and quickly submitted to the PMP database (6000) through the PMP accessing system (1000) and a prescription report is generated (7000) to be scrutinized by the PMP user.

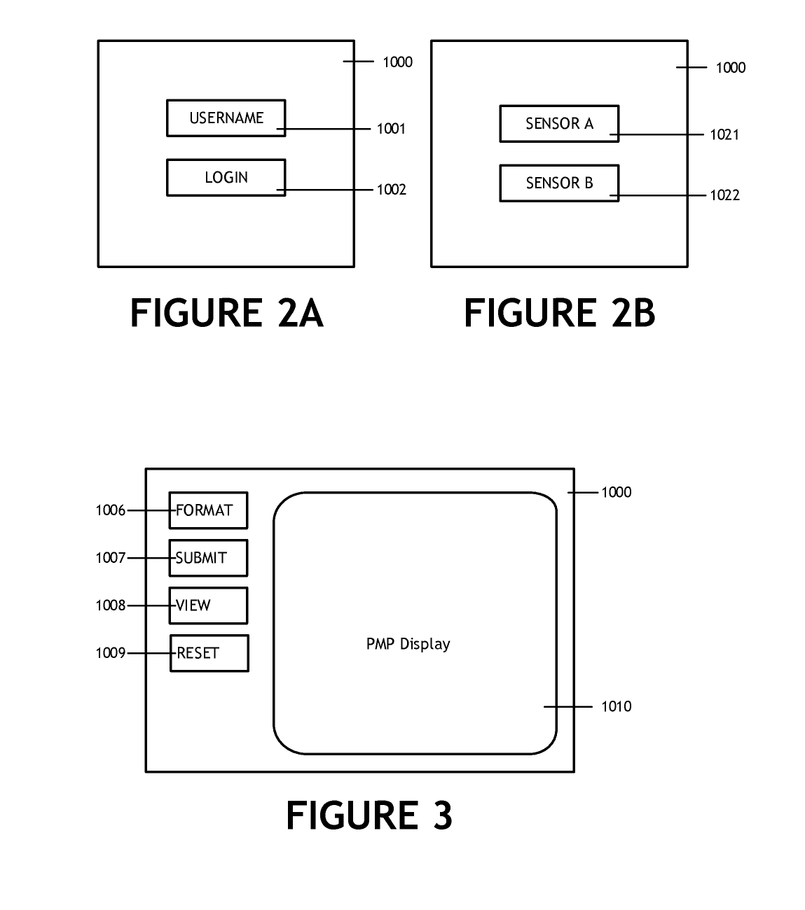

Referring now to FIG. 2A, in one preferred embodiment of the invention the PMP user will provide an identifier (1001) to login (1002) to the PMP accessing system. The identifier can be a username and password.

Referring now to FIG. 2B, biometrics, such as facial recognition, fingerprints, thumbprint, palm print, retinal scan, facial recognition, voice print, or other means may be used. Multiple biometric sensors [1021 and 1022] provide advanced security for registered users without the need for remembering usernames and passwords. The biometric property is inherent to the registered user. The biometric sensors are accurate, and inexpensive. In still another preferred embodiment, multiple biometrics (facial imaging and fingerprint and voice) are used with passwords and PINs to provide bimodal authentication for a user. The securely stored login information and settings can additionally enable auto-login of the PMP user to their PMP, bypassing the need for multiple logins.

Referring to FIG. 3, in one preferred embodiment, the PMP user will have gained full access to the PMP accessing system (1000) through logging in resulting in access to their preferred PMP (1010) and the efficient user-interface (1006, 1007, 1008, and 1009) included within the current invention.

The PMP user can now quickly and efficiently format (1006) the demographic information (2000) by pressing a single button. The PMP accessing system will programmatically manipulate the demographic information using C Sharp (C#), PHP: Hypertext Preprocessor, a server-side scripting language, or other programming language. The result of the format is a string of text having the patient's identifying demographics which is then parsed, using the aforementioned programming techniques, often including, but not limited to, first name, last name, birth date, state, and zip code all of which are stored as individual variables within the PMP accessing system. The individual variables are used to auto-populate the PMP request fields through, but not limited to, programmatically using the API or directly into the PMP form fields disposed within the PMP accessing system. The PMP user will review the parsed demographic information and, if appropriate, will submit (1007) the data to the PMP through the PMP accessing system.

The submission (1007) process can be achieved through, but not limited to, the PMP (1010) disposed with the PMP accessing system (1000) or utilizing the submission (1007) feature, which will programmatically select the submit action within the already existing PMP. Following submission (1007) of the demographic information, to the PMP, the user will have the ability to view (1008) the report generated by the PMP by means of, but not limited to, the PMP display (1010) or through the PMP accessing system alternate user-interface (see FIG. 6, 1012). Once the PMP user has viewed (1008) the report through the PMP display (1010) or the alternate PMP accessing system report display (1012), they are able to reset (1009) the system to clear all of the stored variables and return the system to its ready to receive data state.

The PMP display (1010) includes the visual representation of the preferred PMP through, but not limited to, a web-browser functionality displaying Hypertext Markup Language (HTML), Cascading Style Sheets (CSS), or the like within the PMP accessing system of the present invention (1000). The PMP accessing system of the present invention (1000) can programmatically interact with the PMP (6000) within the system (1000) enabling the transfer of data (2000) directly to the PMP (6000).

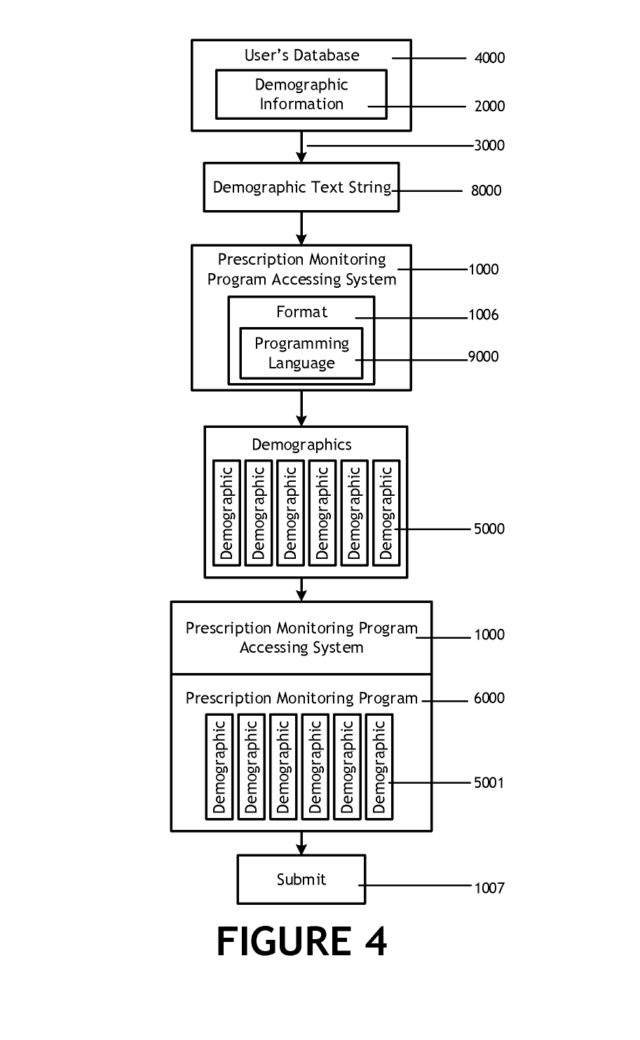

Referring now to FIG. 4, a schematic representation of the flow regarding demographic information (2000) programmatically formatted (1006) by the PMP accessing system of the present invention (1000) and submitted (1007) to the PMP database (6000) for report (7000) generation and viewing (1010 and 1012).

The demographic information (2000) included within the user's existing database (4000) is isolated through, but not limited to, copy and paste functionality, scan, upload, optical character recognition, application programming interface (API) connectivity, or screen capture (3000). The isolated information is stored as, but not limited to, a single string of text (8000), through, but not limited to, the clipboard function on a typical computer, a Portable Document Format (PDF) file, comma separated file (CSV), or the like.

The PMP accessing system of the present invention formats (1006) the string of text by utilizing C Sharp (C#), PHP: Hypertext Preprocessor, a server-side scripting language, or other programming language. The result of the format (1006) is a parsed, or divided, set of demographics (5000) including each one of the specific demographic data points (5001), temporarily stored as individual variables required by the PMP (6000). The format (1006) will auto-populate the new set of individual demographic data points (5001) programmatically through, but not limited to, direct auto-population of the required text fields, or through the application programming interface (API), for submission (1007) and report (7000) generation.

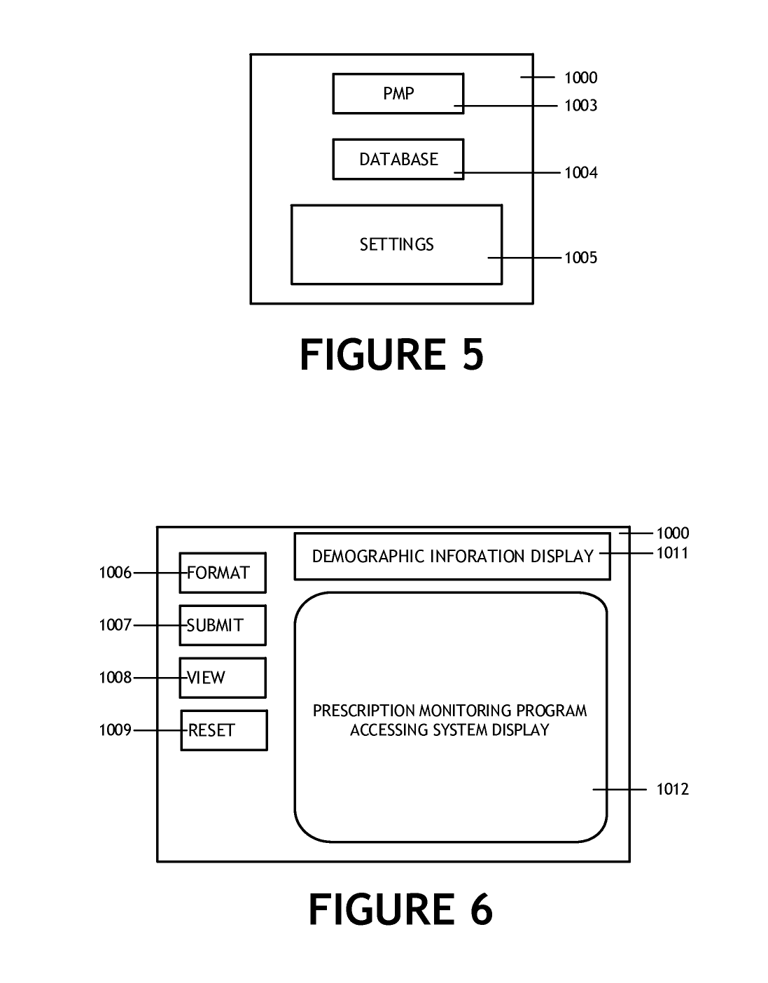

Referring now to FIG. 5, the PMP accessing system of the present invention can store settings similar, but not limited to, the specific PMP (1003) regularly utilized, the name of the user's database including the initial demographic information (1004), such as an EHR or the like, and other settings (1005) specific to the PMP (6000) for easier use. The settings may be stored in, but not limited to, a MySQL database or the like, stored on a remote, secure server, or stored within the PMP accessing system of the present invention itself for easy and secure retrieval. These settings will be loaded when the PMP user logs into the PMP accessing system of the present invention enabling the system to adjust the programming code required for each setting.

Referring now to FIG. 6, an alternate preferred embodiment of the PMP accessing system of the present invention (1000) user-interface involving similar functionality (1006, 1007, 1008, and 1009) as FIG. 3 with an alternate display of the reported information. Following a format (1006), the demographic information (5001) is displayed for review and correction, if needed, and submitted (1007) to the PMP (6000) through the PMP accessing system of the present invention (1000). The report generated can be displayed within the PMP Accessing System Report Display (1012) in different ways to better assist the PMP user in navigating the information reported.

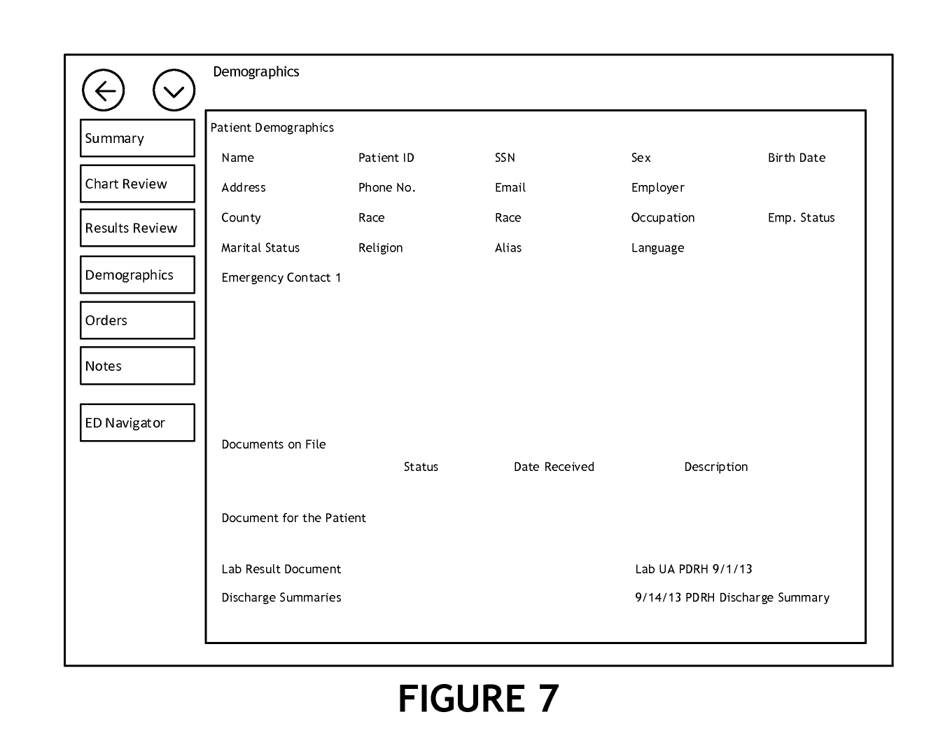

Referring now to FIG. 7, an example of a user's information database, electronic health record (EHR), displaying demographic information that is required by the PMP (6000) to obtain the prescription report (7000). This information is isolated from the database through, but not limited to, copy and paste functionality, scan, upload, optical character recognition, application programming interface (API) connectivity, or screen capture (3000).

The PMP accessing system of the present invention can exist as a stand-alone utility such as a website, desktop, laptop, tablet, mobile phone, or other electronic application, web browser toolbar application, fully integrated utility within a particular PMP system, or within an existing electronic database such as an EHR.

In the stand-alone utility, the PMP user logs in through the system and submits the patient demographic information required by the particular PMP. The user is automatically logged into the PMP when logging into the PMP accessing system of the present invention with their specific login information.

The PMP accessing system of the present invention can be fully integrated as part of the specific PMP system. The PMP user logs into the specific PMP in the required fashion and will be presented with the option to upload, format, and submit all patient demographic information from their electronic database.

In another embodiment, the PMP accessing system of the present invention can also be a web browser add-on which will enable a user to access said system via an application which is located on the toolbar of their chosen web browser. This functions the same as the PMP accessing system of the present invention, enabling a user to upload, format, and submit patient information to the PMP.

There are many benefits to this type of system including but not limited to; improved compliance and usage of regional, state, provincial, multi-state, private or national system PMPs, decreased time spent on logging and submitting requests to targeted PMP systems, decreased errors in personal information transcription, increased accuracy of reports generated, improved prescribing habits of health care provides, and improved dispensing habits of pharmacists.

Common complaints today include length of time to login to the PMP, length of time filling in the form with the personal demographic information, and transcription errors leading to repeat attempts at obtaining a report. While these are user-side issues, there are ways to improve the process and make it more efficient, especially for those using electronic medical records or other electronic information databases (pharmacy based, criminal justice, or the like).

With the number of different systems needing electronic medical records, PMP user all too often find themselves manually inputting the request for a prescription report through the targeted PMP. This can be cumbersome, time consuming, and result in erroneous entries.

The PMP accessing system of the present invention enables PMP users the ability to quickly enter patient demographic information into the regional, state, provincial, multi-state, private or national system PMP with minimum downtime, while also preventing mistakes enabling the system to perform the necessary formatting of patient demographic information automatically.

In yet another preferred embodiment of the PMP accessing system of the present invention, batch processing is used when a large number of records need to be processed. This type of processing may be desirable in law enforcement applications or office based medical practices where large volumes of patients are seen daily.

Congress has demonstrated a particular interest in facilitating interoperability among state-level PMPs, as well as in establishing national programs. Policy makers have focused on enhancing state-level databases and interstate information sharing, and some have suggested establishing a national system. A related issue that policy makers may consider is whether PMPs and their interstate information sharing platforms adequately protect personally identifiable and related health information and whether they can ensure that patients with legitimate medical needs have access to prescriptions.

Throughout this application, various patents and applications are referenced by number and inventor. The disclosures of these documents in their entireties are hereby incorporated by reference into this specification in order to more fully describe the state of the art to which this invention pertains.

It is evident that many alternatives, modifications, and variations of the PMP accessing system of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

I claim:

1. A system comprising:
a PMP accessing system that is compatible with a PMP user device, said PMP user device enabling user login and user retrieval of patient medical records from a PMP database in said PMP system for a PMP user, said PMP accessing system enabling formatting of demographic data for said patient from said PMP database to comply with specific demographic information requirements of said PMP system, said formatting resulting in a string of text with identifying demographics for said patient, said string of text being parsed and stored as individual variables within said PMP accessing system, said individual variables auto-populating PMP request fields within said PMP accessing system, said PMP accessing system enabling said PMP user to review said parsed demographic data of said patient within said PMP accessing system prior to submission of said data to said PMP database.

2. The system of claim 1, wherein said PMP accessing system enables the PMP user to format the demographic information by pressing a single button.

3. The system of claim 1, further comprising means for generating a prescription report for any individual or entity having authorized access to said PMP system.

4. The system of claim 1, wherein said prescription monitoring program accessing system is a web browser.

5. The system of claim 1, wherein said prescription monitoring program accessing system is a stand-alone utility.

6. The system of claim 1, wherein said prescription monitoring program accessing system is fully integrated as part of said PMP system.

7. The system of claim 1, wherein said prescription monitoring program accessing system is fully integrated within an EHR.

8. The system of claim 1, wherein said login includes a biometric sensor.

9. The system of claim 8, wherein said biometric login is bimodal.

10. A method for accessing data for a patient in a PMP database through a user database, said method comprising:
logging into a PMP system from said user database by a medical health professional, a medical health professional designee, a pharmacist, or a pharmacist designee, said PMP system being a regional, a state, a provincial, a multi-state, a private or a national system;
retrieving demographic data of said patient by said medical health professional, a medical health professional designee, a pharmacist, or a pharmacist designee from said PMP database;
formatting said demographic data for said patient from said PMP database to comply with specific demographic information requirements of said PMP system, said formatting resulting in a string of text with identifying demographics for said patient, said string of text being parsed and stored as individual variables within a PMP accessing system, said individual variables being used to auto-populate the PMP request fields within a PMP accessing system; and
enabling said PMP user to review said parsed demographic data of said patient within said PMP accessing system prior to submission of said data to said PMP database.

11. The method of claim 10, further comprising generating a prescription report by any individual or entity having authorized access to said PMP system for any patient.

12. The method of claim 10, wherein said PMP accessing system enables said PMP user to format said demographic information of said patient by pressing a single button.

13. The method of claim 10, wherein said login is performed with biometrics.

14. The method of claim 13, wherein said biometric login is bimodal.

15. A system comprising:
a PMP accessing system that is compatible with a PMP user device, said PMP user device enabling user login and user retrieval of patient medical records from a PMP database in said PMP system for a PMP user, said PMP accessing system enabling formatting of demographic data for said patient from said PMP database to comply with specific demographic information requirements of said PMP system;
whereby said PMP accessing system enables submission of current patient demographic information into a PMP database using varying formats;
whereby said PMP accessing system circumvents a need for manual input of patient data; and
whereby said PMP accessing system uploads patient demographic information as required by each PMP.

16. The system of claim 15, wherein said PMP accessing system enables the PMP user to format the demographic information by pressing a single button.

17. The system of claim 15, further comprising means for generating a prescription report for any individual or entity having authorized access to said PMP system.

18. The system of claim 15, wherein said prescription monitoring program accessing system is a web browser.

19. The system of claim 15, wherein said prescription monitoring program accessing system is a stand-alone utility.

20. The system of claim 15, wherein said prescription monitoring program accessing system is fully integrated as part of said PMP system.
